(19) United States
(12) Patent Application Publication
(10) Pub. No.: US 2017/0174355 A1
(43) Pub. Date: Jun. 22, 2017

(54) TAIL ROTOR DRIVE SYSTEMS

(71) Applicant: Sikorsky Aircraft Corporation, Stratford, CT (US)

(72) Inventors: Peter J. Waltner, Royal Palm Beach, FL (US); Frederick L. Bourne, Litchfield, CT (US); Joseph L. Simonetti, Southbury, CT (US); James R. Malo, Barkhamsted, CT (US)

(21) Appl. No.: 15/355,773

(22) Filed: Nov. 18, 2016

Related U.S. Application Data
(60) Provisional application No. 62/271,104, filed on Dec. 22, 2015.

(51) Int. Cl. B64D 31/06; B64C 27/04; B64D 27/10; B64D 35/00; B64D 41/00; B64C 27/82; B64D 27/24

(52) U.S. Cl. CPC B64D 31/06; B64C 27/82; B64C 27/04; B64D 27/24; B64D 35/00; B64D 41/00; B64D 27/10; B64C 2027/8209; B64D 2027/026

(57) ABSTRACT

A helicopter includes a tail rotor, a primary drive system operatively connected to the tail rotor, and a secondary drive system operative connected to the tail rotor. The secondary drive system is configured to supplement torque provided to the tail rotor by the primary drive system. Related tail rotor drive systems and methods of applying torque to tail rotors are also described.

### CROSS-REFERENCE TO RELATED APPLICATION

This application claims the benefit of priority under 35 U.S.C. §119(e) to U.S. Provisional Application No. 62/271,104, filed Dec. 22, 2015, which is incorporated herein by reference in its entirety.

### BACKGROUND OF THE INVENTION

1. Field of the Invention

The present disclosure relates to rotorcraft, and more particularly to tail rotor drive systems for rotorcraft.

2. Description of Related Art

Rotorcraft like helicopters commonly include a main rotor system and an anti-torque system connected by a gear assembly to an engine. The engine provides mechanical rotation to the main rotor system such that rotor blades of the main rotor system rotate about the rotorcraft airframe and provide lift to the rotorcraft. The rotation of the main rotor blades about the airframe also applies torque to the rotorcraft airframe, which tends to rotate the airframe in the direction opposite that of rotation of the main rotor blades. The anti-torque system counteracts the torque applied by the main rotor system by generating thrust with a force component that opposes the torque, typically using rotational power applied to a tail rotor system through a gear assembly. Where the main rotor system and the anti-torque rotor system, e.g., a tail rotor system, are mechanically coupled to one another and rotate at fixed rotational speeds relative to one another, the angle of attack of the tail rotor blades is varied as necessary to counteract the constantly varying amount of power or torque applied to the main rotor system as the rotorcraft maneuvers during flight. In some rotorcraft, the gear assembly receiving torque for the tail rotor system has a torque limit. Since the thrust generated by the tail rotor system is a function of the torque input to the trail rotor system through the gear assembly, and the thrust generated by the tail rotor system counteracts torque applied to the rotorcraft by rotation of the rotor blades of the main rotor system, the gear assembly torque limit can also limit the amount of power that can be input to the main rotor system, potentially limiting performance of the rotorcraft.

Such conventional methods and systems have generally been considered satisfactory for their intended purpose. However, there is still a need in the art for improved tail rotor drive systems. The present disclosure provides a solution for this need.

### SUMMARY OF THE INVENTION

A helicopter includes a tail rotor, a primary drive system operably connected to the tail rotor, and a secondary drive system operably connected to the tail rotor. The secondary drive system is configured to supplement torque provided to the tail rotor by the primary drive system.

In certain embodiments, the helicopter can include an engine operably coupled to the tail rotor through the primary drive system. The secondary drive system can include an overrunning clutch connected to the tail rotor. A ring gear can be connected to the overrunning clutch. The secondary drive system can include an electric motor with a pinion gear, and the pinion gear can be intermeshed with the ring gear. The helicopter can include an electric power source, and the electric power source can be connected to the electric motor through leads extending along a tail boom of the helicopter. The electric power source can be a battery, a capacitor, a generator, or a combination thereof, operably connected to the engine of the helicopter. The electric motor can be connected to a tail rotor pylon rotatably supporting the tail rotor. It is also contemplated that the electric motor can be operably connected to a drive shaft of the primary drive system disposed between a main gearbox or an intermediate gearbox and the tail rotor.

In accordance with certain embodiments, the secondary drive system can include an electrical machine operatively coupled to the tail rotor. The electric machine can include a winding connected to the electric power source. The winding can be fixed relative to the helicopter, and a permanent magnet of the electric machine can be fixed relative to the tail rotor. The winding can be fixed relative to the tail rotor, and the permanent magnet of the electric machine can be fixed relative to the helicopter. The winding can be a first winding fixed relative to the helicopter, and the electric machine can include a second winding fixed relative to the tail rotor and connected to the electric power source through a dynamic power transfer device like a rotating transformer or slip ring assembly.

It also contemplated that, in accordance with certain embodiments, the secondary drive system can include a pressurized fluid source operably coupled to the tail rotor through the secondary drive system. For example, an overrunning clutch connected to the tail rotor, a torque converter can be connected to the overrunning clutch, a fluid supply conduit can be connected between the torque converter with the pressurized hydraulic fluid source, and a fluid return conduit can be connected between the torque converter and the hydraulic fluid source. Alternatively, a ring gear can be connected to the overrunning clutch and a hydraulic motor with a pinion gear intermeshed with the ring gear can be coupled to the tail rotor. The hydraulic motor can include an inlet and an outlet in fluid communication with the pressurized hydraulic fluid source. It is contemplated that the hydraulic motor can be disposed external of or within a tail rotor gearbox of the primary drive system.

It is further contemplated that secondary drive system can include a pressurized gas source operably coupled to the tail rotor through the secondary drive system. The second drive system can include an expansion turbine with a rotor portion and a stator portion. The rotor portion of the expansion turbine can be fixed relative to the tail rotor and the stator portion can be fixed relative to the helicopter. A plenum can be in connected to the expansion turbine and in fluid communication with the expansion turbine and the pressurized gas source. It is contemplated that the pressurized gas source can include one or more of a compressor section of a main engine, a compressor section of an auxiliary power unit, and an auxiliary compressor.

A method of applying torque to a helicopter tail rotor includes receiving a main rotor or tail rotor torque setting and comparing the received tail rotor torque setting to a predetermined torque setting. The received torque setting and the predetermined torque setting may be torque limits, torque threshold, and may be dependent upon the operation mode of the helicopter. The method also includes applying torque to a tail rotor using a primary drive system. The method further includes applying torque to the tail rotor using a secondary drive system if the received tail rotor torque setting is greater than the predetermined torque setting. In certain embodiments the method can further include determining torque applied to the tail rotor by the primary drive system at a location on the primary drive system, such as between a main gearbox and an intermediate gearbox of the primary drive system, and applying the torque to the primary drive system at a location between the location where torque is determined and the tail rotor.

A helicopter tail rotor drive system includes a tail rotor, a primary drive system connected to the tail rotor, a secondary drive system connected to the tail rotor by the primary drive system, and a control module operative associated with the primary and secondary drive systems. The control module has instructions that, when read by the control module cause the control module to receive a tail rotor torque setting, compare the tail rotor torque setting to a predetermined torque setting, apply torque to a tail rotor using a primary drive system if the received tail rotor torque setting is less than the predetermined torque setting, and apply torque to the tail rotor using a secondary drive system if the received tail rotor torque setting is greater than the predetermined torque setting.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a perspective view of an exemplary embodiment of a helicopter constructed in accordance with the present disclosure, showing a main rotor drive system, a tail rotor primary drive system and a tail rotor secondary drive system;

FIG. 2 is a schematic view of the main rotor and tail rotor drive systems of FIG. 1, showing an electric motor of the supplemental drive system operably connected to a drive shaft of the tail rotor primary drive system, according to an embodiment;

FIG. 3 is a schematic view of the supplemental drive system of FIG. 1, showing an electric motor operably connected to the tail rotor system, according to an embodiment;

FIG. 4 is a schematic view of the supplemental drive system of FIG. 1, showing an electric machine connected to the tail rotor system, according to an embodiment;

FIG. 5 is a schematic view of the supplemental drive system of FIG. 1, showing a hydraulic torque converter and overrunning clutch connected to the tail rotor system, according to an embodiment;

FIG. 6 is a schematic view of the supplemental drive system of FIG. 1, showing a hydraulic torque converter directly connected to a tail rotor shaft of the tail rotor system, according to an embodiment;

FIG. 7 is a schematic view of the supplemental drive system of FIG. 1, showing a hydraulic motor and overrunning clutch operably connected to the tail rotor system, according to an embodiment;

FIG. 8 is a schematic view of the supplemental drive system of FIG. 1, showing a hydraulic motor directly connected to a tail rotor shaft of the tail rotor system, according to an embodiment;

FIG. 9 is a schematic view of the supplemental drive system of FIG. 1, showing a pneumatically driven turbine operably connected to the tail rotor system, according to an embodiment;

FIG. 10 is a diagram of a method of applying torque to a helicopter tail rotor, showing operations of the method.

### DETAILED DESCRIPTION OF THE PREFERRED EMBODIMENTS

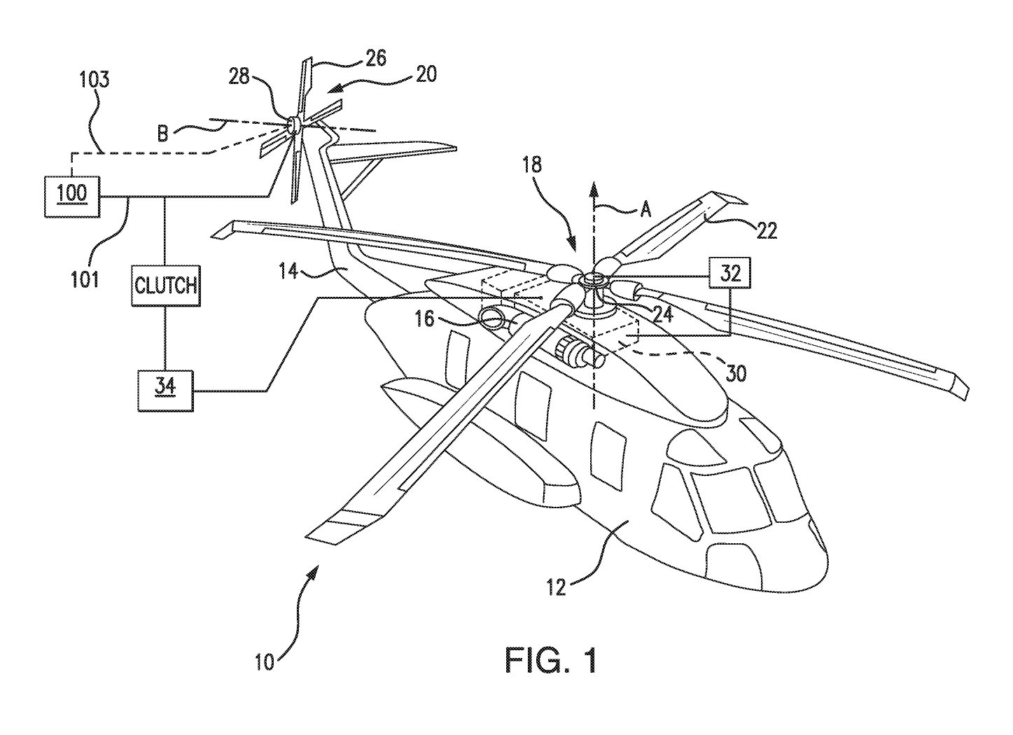

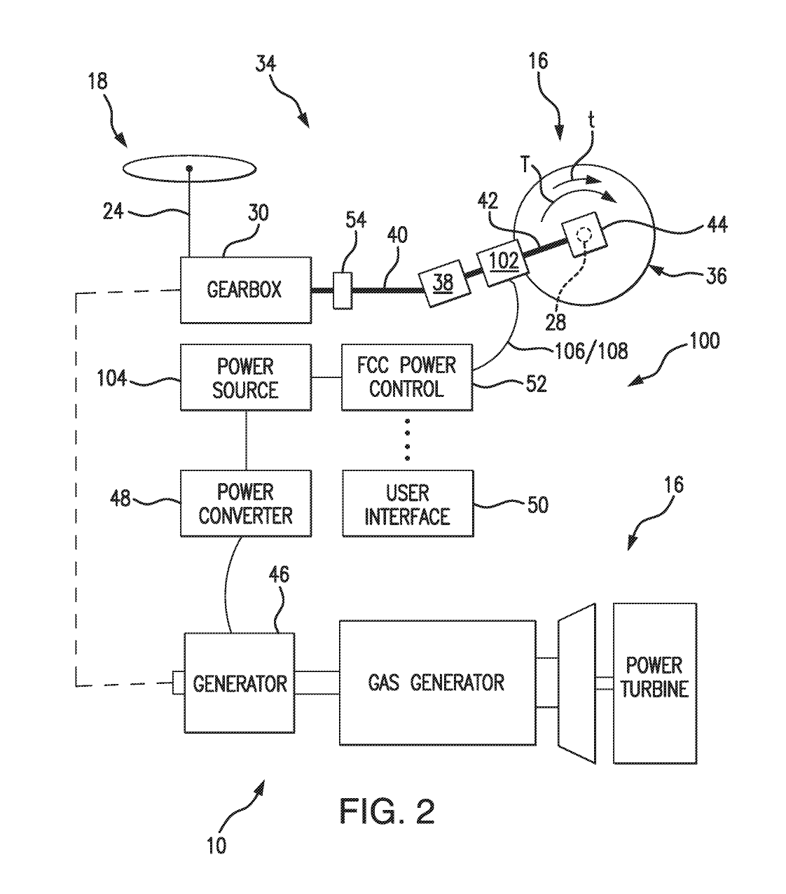

Reference will now be made to the drawings wherein like reference numerals identify similar structural features or aspects of the subject disclosure. For purposes of explanation and illustration, and not limitation, a rotorcraft with primary and second tail rotor drive systems in accordance with the disclosure is shown in FIG. 1 and is designated generally by reference character 10. Other embodiments of rotorcraft and tail rotor secondary drive systems are provided in FIGS. 2-10, as will be described. The systems and methods described herein can be used in helicopter rotorcraft, however the invention is not limited to any particular type of rotorcraft or to aircraft in general.

Referring now FIG. 1, helicopter 10 is shown. Helicopter 10 includes an airframe 12 with a longitudinally extending tail 14. Airframe 12 includes one or more engines 16 and rotatably supports a main rotor system 18 and a tail rotor system 20. Main rotor system 18 includes main rotor blades 22, which are connected to a main rotor shaft 24 configured for rotation about a main rotor axis A. Tail rotor system 20 includes tail rotor blades 26, which are connected to a tail rotor shaft 28 that is configured for rotation about a tail rotor axis B. Tail rotor system 20 is configured as an element of an anti-torque system and is arranged such that thrust generated by rotation of tail rotor system 20 exerts a force on longitudinally extending tail 14 that opposes torque applied to airframe 12 by main rotor system 18. Although a particular configuration of helicopter is illustrated in FIG. 1 and described herein, it is to be appreciated and understood that other types of aircraft and mechanical power transmissions generally can benefit from the present disclosure.

Helicopter 10 includes a gearbox 30, a main rotor drive system 32, a tail rotor primary rotor drive system 34, and a tail rotor secondary drive system 100. Main rotor drive system 32 interconnects gearbox 30 with main rotor system 18, and provides rotational energy received from engine 16 to main rotor system 18. Tail rotor primary drive system 34 interconnects tail rotor system 20 with gearbox 30, and provides rotational energy received from engine 16 to tail rotor system 20 such that tail rotor blades 26 rotation about tail rotor axis B with a rotational speed that corresponds to the speed at which main rotor blades 22 rotate about main rotor axis A. Tail rotor secondary drive system 100 is operably coupled to tail rotor system 20 and is configured to supplement torque applied by tail rotor primary drive system 34 to tail rotor system 20, increasing available torque beyond that provided the tail rotor primary drive system 34 by tail rotor system 20.

Referring now to FIG. 2, transmission elements of helicopter 10 are shown schematically. Helicopter 10 includes a tail rotor 36, tail rotor primary drive system 34 operably connected to tail rotor 36, and tail rotor secondary drive system 100 operably connected to tail rotor 36. Tail rotor secondary drive system 100 is configured to supplement a primary torque T provided to tail rotor 36 by tail rotor primary drive system 34 with a secondary torque t. Secondary torque t provides increased transient tail rotor power to tail rotor 36. It is contemplated that tail rotor secondary drive system 100 allows additional impressed pitch, enhancing maneuverability of helicopter 10.

Tail rotor secondary drive system 100 includes an electric motor 102. Electric motor 102 is operably connected to a tail rotor shaft 28 of tail rotor primary drive system 34. In the illustrated exemplary embodiment, tail rotor primary drive system 34 includes an intermediate gearbox 38 interposed between a first drive shaft 40 and a second drive shaft 42. First drive shaft 40 interconnects gearbox 30 with intermediate gearbox 38, and second drive shaft 42 interconnects intermediate gearbox 38 with a tail rotor gear box 44. Tail rotor shaft 28 connects tail rotor 36 with tail rotor gearbox 44, tail rotor 36 receiving torque T from tail rotor primary drive system 34 second drive shaft 42 and tail rotor gearbox 44.

Tail rotor secondary drive system 100 also includes a power source 104 that is electrically connected to electric motor 102 through a source lead 106 and a return lead 108. Power source 104 can include a primary generator, an auxiliary generator, a battery, a capacitor, a flywheel energy storage device, or any other source of electrical power. In the illustrated exemplary embodiment, power source 104 is a high voltage battery configured for applying high voltage alternating current (AC) power or direct current (HVDC) power to the electric motor. In embodiments, power source 104 can be a 200-volt or greater AC power source or a 270-volt or greater HVDC power source. This allows electric motor 102 to be a high-torque motor coaxially arranged with second drive shaft 42, allowing for engagement of tail rotor secondary drive system 100 with tail rotor primary drive system 34 in a relatively compact arrangement. In certain embodiments, electric motor can deliver 4.5 foot-pounds of torque or greater for each unit of horsepower applied to the tail, for example delivering more than 100 horsepower to the tail rotor system at the operating rotational speed of the tail rotor system.

Power source 104 is in turn connected to a generator 46. Generator 46 is operably connected to engine 16 and configured to provide high voltage variable frequency alternating current power, which an intervening power converter 48 converter into high voltage direct current (DC) power suitable for charging power source 104. Generator 46 may be a high-speed generator, for example rotating in concert with engine 16 at speeds of around 24,000 rotations per minute through a direct coupling to engine 16. This arrangement allows for re-charging power source 104 subsequent to discharge events during flight, such as when additional torque is intermittently required for maneuvering helicopter 10. It is to be understood and appreciated that electric motor 102 can also be an alternating current power motor, such as a three-phase alternating current power motor, or any other suitable type of electric motor.

Application of second torque t is controlled through a controller 52 configured to control the application of electric power to electric motor 102. In embodiments, controller 52 may be circuitry and/or software incorporated into a flight control computer (FCC) or a full authority digital engine control (FADEC) operatively connected to electric motor 102. Controller 52 is operably connected between power source 104 and electric motor 102, and is configured to receive data relating to primary torque T from a primary torque sensor 54 connected to first drive shaft 40. This allows for monitoring torque applied to tail rotor 36, and in the illustrated exemplary embodiment reporting torque to a user interface 50 connected to controller 52. In embodiments, tail rotor torque can be monitored and supplemental torque applied, either automatically or through a user input received through user interface 50, when a predetermined threshold is exceeded or when tail rotor power is degraded, such as when helicopter 10 is in an operational regime where the entire rotor system is operating at a lower than normal rotational speed. In such states, i.e. drooped NR states, the tail rotor secondary drive system can provide power such that the tail rotor pitch may be set to a higher value than would otherwise be possible due to the input torque or power limit of the main gearbox and/or intermediate gearbox, thus allowing the tail to provide relatively high thrust (and thus directional control) while the rotorcraft operates in a drooped NR state.

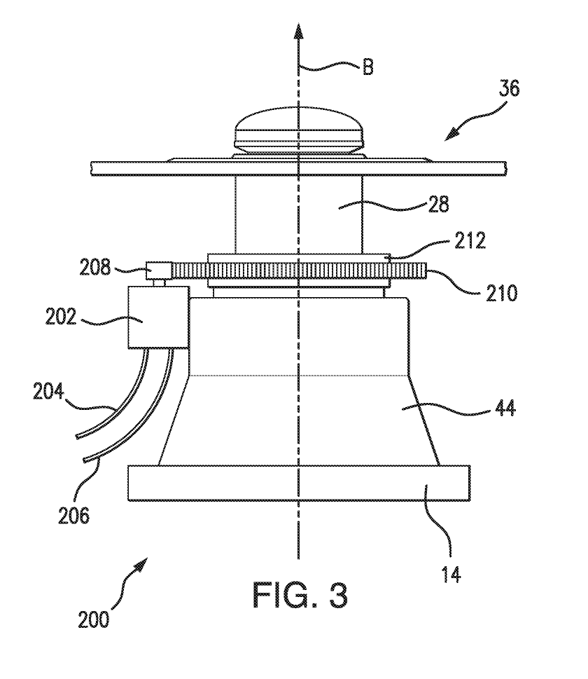

With reference to FIG. 3, a tail rotor secondary drive system 200 is shown, according to an embodiment. Tail rotor secondary drive system 200 is similar to tail rotor secondary drive system 100 and additionally includes an electric motor fixed to tail rotor gearbox 44, a source lead 204, and a return lead 206. Source lead 204 and return lead 206 extend along longitudinally extending tail 14 (shown in FIG. 1) and connect power source 104 (shown in FIG. 2) with electric motor 202 for applying supplemental torque t (shown in FIG. 2) directly to tail rotor shaft 28. This can reduce the size of intermediate gearbox 38 and/or tail rotor gearbox 44 as either or both gearboxes need only be sized to provide primary torque T (shown in FIG. 2) to tail rotor 36.

Electric motor 202 includes a pinion gear 208. Teeth (not shown for reasons of clarity) of pinion gear 208 intermesh with teeth of a ring gear 210 disposed circumferentially about tail rotor axis B. Ring gear 210 is connected with an overrunning clutch 212, which selectively engages tail rotor shaft 28 when electric motor applies torque to ring gear 210. This allows for the application of supplemental torque to tail rotor system 20 independent of torque applied by tail rotor primary drive system 34 (shown in FIG. 1).

Source lead 204 and return lead 206 extend along longitudinally extending tail 14 (shown in FIG. 1) of helicopter 10 (shown in FIG. 1) and connect electric motor 202 with power source 104. Electric motor 202 is fixed relative to tail rotor gearbox 44 and arranged such that teeth of pinion gear 208 intermesh with teeth of ring gear 210. Ring gear 210 is rotatably fixed to tail rotor gearbox 44, and is driveably engaged to overrunning clutch 212. Overrunning clutch 212 has first and second rotatable elements that selectively engage one another when the rotational speed of ring gear 210 exceeds the rotational speed of tail rotor system 20. As will be appreciated by those of skill in the art in view of the present disclosure, this allows power from power source 1042 to be applied as torque to tail rotor system 20, which supplements torque applied to tail rotor system 20 by tail rotor primary drive system 34 when operated coincidently with one another. It is to be appreciated and understood that power source 104 can be an electric power source such as a primary generator, an auxiliary generator, a battery, a capacitor, a flywheel energy storage system, or any other suitable power source.

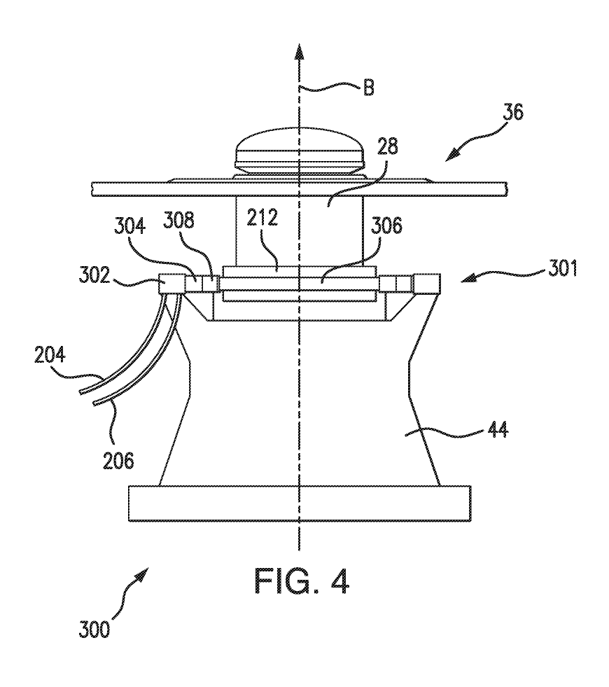

With reference to FIG. 4, a tail rotor secondary drive system 300 is shown, according to an embodiment. Tail rotor secondary drive system 300 is similar to tail rotor secondary drive system 200 (shown in FIG. 2), and additionally includes an electrical machine 301. Electrical machine 301 includes a stator portion 302 with an electromagnetic element 304 and a rotor portion 306 with an electromagnetic element 308. Stator portion 302 is fixed relative to tail rotor gearbox 44 and rotor portion 306 is fixed to overrunning clutch 212.

One or both of electromagnetic element 304 and electromagnetic element 308 includes a magnetic coil. In the illustrated exemplary embodiment, electromagnetic element 304 includes a magnetic coil that is electrically connected to power source 104 (shown in FIG. 2) by source lead 204 and return lead 206. Upon application of power to electromagnetic element 304, stator portion 302 becomes electromagnetically coupled to electromagnetic element 308 of rotor portion 306, thereby exerting an electromotive force against rotor portion 306. The force causes overrunning clutch 212 to rotate, and upon reaching the rotational speed at which tail rotor shaft 28 is rotating, overrunning clutch 212 applies supplemental torque t (shown in FIG. 2) on tail rotor shaft 28. This adds torque or power to tail rotor system 20, which is additive with torque or power provided by tail rotor primary drive system 34.

It is contemplated that electromagnetic element 308 can include a magnetic coil or a permanent magnetic, as suitable for a given application. Permanent magnets have the advantage of not requiring electrical power transfer across a gap and may serve as a store of momentum. Magnetic coils are relatively lightweight, and may receive power through a rotary transformer or slip ring arrangement.

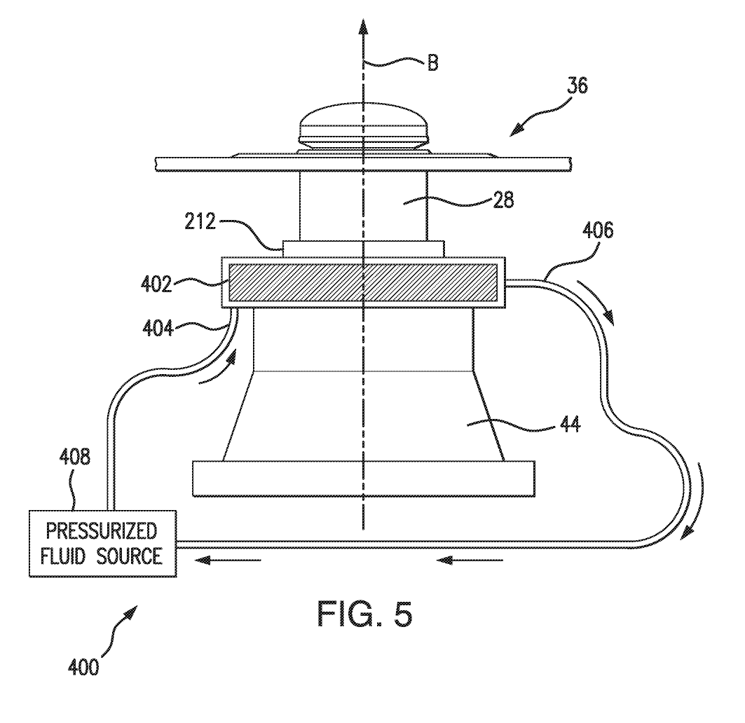

With reference to FIG. 5, a tail rotor secondary drive system 400 is shown. Tail rotor secondary drive system 400 is similar to tail rotor secondary drive system 200 (shown in FIG. 2), and additionally includes a hydraulic power torque converter 402, a supply conduit 404, a return conduit 406, and pressurized fluid source 408. Torque converter 402 is connected to pressurized fluid source 408 through supply conduit 404, is in fluid communication with pressurized fluid source 408 therethrough, and receives a supply of pressurized fluid corresponding to a desired amount of supplemental torque t (shown in FIG. 2) desired for application to tail rotor system 20. Torque converter 402 is also in fluid communication with pressurized fluid source 408 through return conduit 406, through which low-pressure fluid returns to pressurized fluid source 408. It is contemplated that pressurized fluid source can include a pump, an accumulator, a lubrication system of gearbox 30 (shown in FIG. 1) or any other suitable source of pressurized hydraulic fluid. Torque converter 402 and overrunning clutch 212 reduce fluidic drag associated with tail rotor secondary drive system 400 when torque or power is not being supplied through the system while allowing for use of a completely closed hydraulic system.

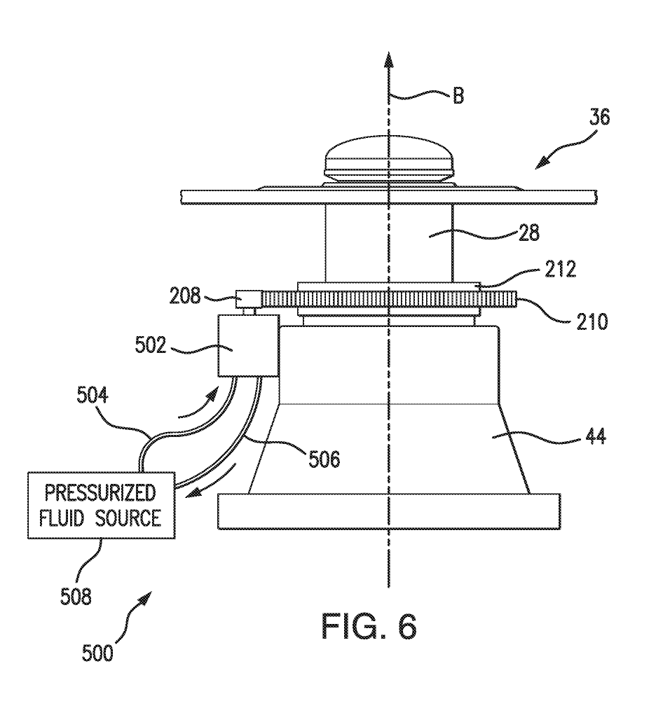

With reference to FIG. 6, a tail rotor secondary drive system 500 is shown, according to an embodiment. Tail rotor secondary drive system 500 is similar to tail rotor secondary drive system 200 (shown in FIG. 2), and additionally includes a hydraulic motor 502, a supply conduit 504, a return conduit 506, and a pressurized fluid source 508. Hydraulic motor 502 fixed to the exterior of tail rotor gearbox 44 and is configured to convert pressure in pressurized fluid provided by pressurized fluid source 508 into secondary torque t (shown in FIG. 2), thereby providing supplemental torque to tail rotor 36 for rotation about tail rotor axis B.

Pressurized fluid source 508 may include a pump, an accumulator, a lubrication system of gearbox 30, or source of pressurized fluid, and is in fluid communication with hydraulic motor 502 through supply conduit 504 to selectively provide a flow of pressurized fluid therethrough. The flow of pressurized fluid rotates pinion gear 208, which is intermeshed with ring gear 210, which in turn is connected to tail rotor shaft 28 through overrunning clutch 212. Low-pressure fluid returns to pressurized fluid source 508 through return conduit 506 subsequent cycling through the hydraulic system (not shown for reasons of clarity).

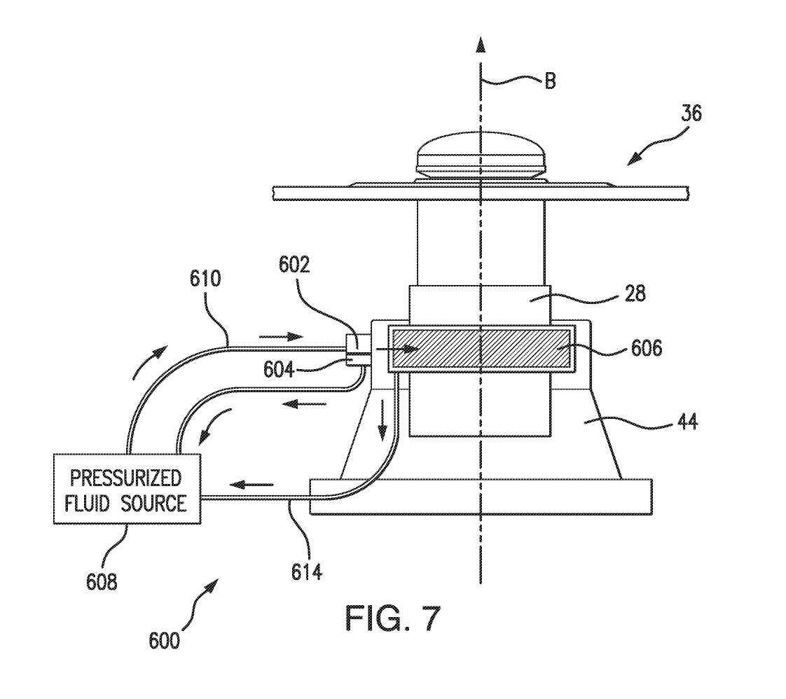

With reference to FIG. 7, a tail rotor secondary drive system 600 is shown, according to an embodiment. Tail rotor secondary drive system 600 is similar to tail rotor secondary drive system 500 (shown in FIG. 5), and additionally include a throttling valve 602, a bypass valve 604, and a torque converter 606. Torque converter 606 is in fluid communication with a pressurized fluid source 608 through a supply conduit 610. Supply conduit 610 is connected to throttling valve 602, which throttles pressurized fluid provided thereto through supply conduit 610 by apportioning the pressurized fluid between torque converter 606 and bypass valve 604. Apportionment of the pressurized fluid is according to a commanded amount of supplemental torque t (shown in FIG. 2) desired to apply to tail rotor 36. Pressurized fluid diverted through bypass valve 604 returns to pressurized fluid source 608 through a bypass conduit. The remainder of the pressurized fluid traverses torque converter 606, which converts the pressure to secondary torque t and returns the fluid to pressurized fluid source 608 through a return conduit 614.

In the illustrated exemplary embodiment, torque converter 606 is integrally connected to tail rotor shaft 28 without an intervening overrunning clutch. This allows for torque converter 606 to be arranged within tail rotor gearbox 44, reducing the size and installation envelope of tail rotor secondary drive system 600. It is to be appreciated and understood that torque converter 606 could be included in intermediate gearbox 38 of tail rotor primary drive system 34.

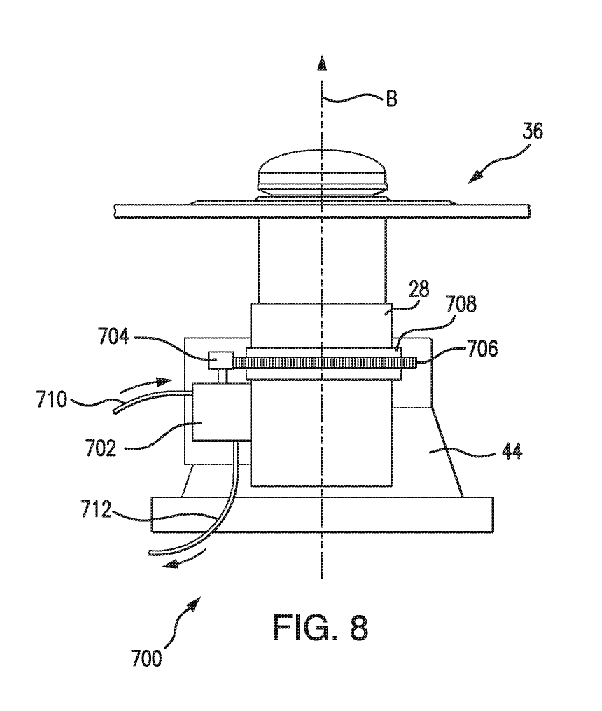

With reference to FIG. 8, a tail rotor secondary drive system 700 is shown, according to an embodiment. Tail rotor secondary drive system 700 is similar to tail rotor secondary drive system 500 (shown in FIG. 6), and additionally include a hydraulic motor 702 with a pinion gear 704, a ring gear 706, and an overrunning clutch 708 that are each disposed within tail rotor gearbox 44. Hydraulic motor 702 is connected to a pressurized fluid source, e.g., pressurized fluid source 508 (shown in FIG. 6) through a supply conduit 710 and a return conduit 712, and receives a flow of pressurized hydraulic fluid therefrom that hydraulic motor converts into secondary torque t (shown in FIG. 2). Secondary torque t is applied to tail rotor shaft 28 through pinion gear 704, which intermeshes with ring gear 706. Ring gear 706 is connected to tail rotor shaft 28 through overrunning clutch 708, which engages tail rotor shaft 28.

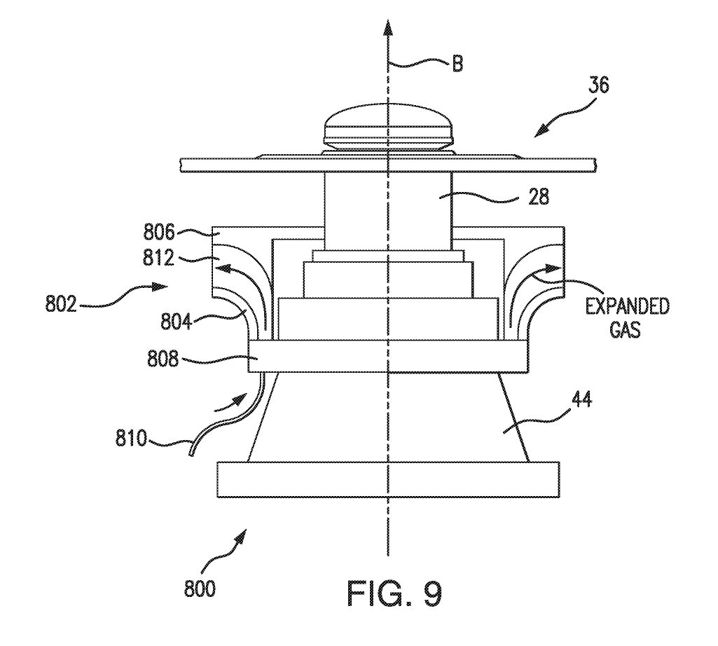

With reference to FIG. 9, a secondary drive system 800 is shown, according to an embodiment. Secondary drive system 800 includes a pneumatic turbine 802 with a stator portion 804 and a rotor portion 806, a plenum 808, and a supply duct 810. Stator portion 804 of pneumatic turbine 802 is fixed to tail rotor gearbox 44; rotor portion 806 of tail rotor gearbox 44 is fixed to tail rotor shaft 28. Stator portion 804 and rotor portion 806 defines therebetween a gas path for converting high-pressure gas deliver to pneumatic turbine 802 into supplemental torque to tail rotor 36.

Supply duct 810 extends along longitudinally extending tail 14 (shown in FIG. 1) and connects a gas generator of engine 16 (shown in FIG. 2), an auxiliary power unit (APU), an auxiliary compressor, or any other suitable source of high-pressure gas carried by the rotorcraft, with plenum 808. Plenum 808 is in fluid communication with pneumatic turbine 802, which provides a high-pressure gas flow from the gas generator to pneumatic turbine 802 according a desired amount of secondary torque t desired for application to tail rotor 36. Pneumatic turbine 802 expands the high-pressure gas flow, extracting work therefrom, and causing rotor portion 806 to apply secondary torque t to tail rotor shaft 28. Expanded gas exits pneumatic turbine 802 through outlets 812 that are substantially orthogonal to tail rotor rotation axis B, allowing for a relatively compact tail rotor package.

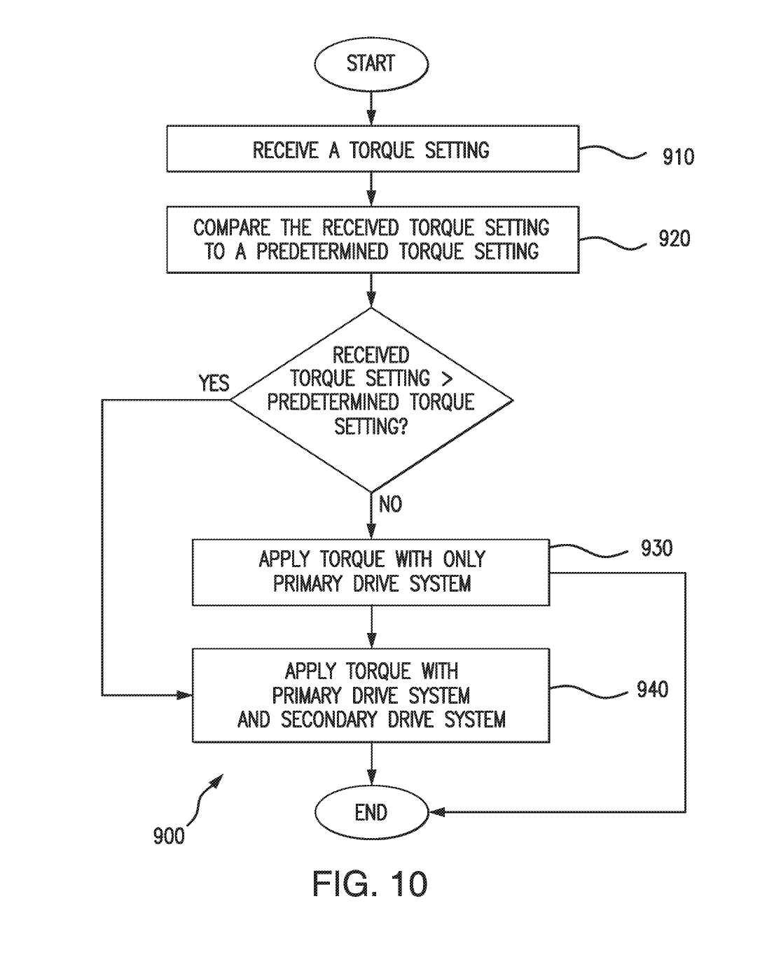

With reference to FIG. 10, a method 900 of applying torque, e.g., supplemental torque t (shown in FIG. 2) to a helicopter tail rotor, e.g., tail rotor system 20 (shown in FIG. 2) includes receiving a tail rotor torque setting, as shown with box 910. The tail rotor torque setting may be received from a controller, such as an FCC or a FADEC, and may be associated with the operating regime of the aircraft. The received torque setting may include a value representative of tail rotor torque or power, tail rotor drive shaft torque or power, a main gearbox torque or power, an engine torque or power, or any other indication of torque within the rotorcraft transmission. The received torque setting is compared to a predetermined torque setting, as shown with box 920. This predetermined torque setting may be representative or a torque limit, a torque threshold, or other torque setting. Torque is applied to the tail rotor up to the lesser of the demanded torque setting and the predetermined torque setting using a primary drive system, e.g. tail rotor primary drive system 34 (shown in FIG. 1), as shown with box 930, and can include determining an amount of torque provided to the tail rotor by the tail rotor primary drive system. If the received setting is above the predetermined torque setting, additional torque is applied to the tail rotor using a secondary drive system, e.g., tail rotor secondary drive system 100, as shown with box 940.

In embodiments described herein, the supplemental tail rotor drive system provides additional torque or power to tail rotor systems. In certain embodiments, the supplemental tail rotor drive system reduces power required to be provided to the tail rotor system through the tail rotor primary drive system, making more power available to the main rotor and providing additional gross weight capability when the aircraft is operating on the input torque limit of the aircraft main gearbox. It is also contemplated that the tail rotor secondary drive system may provide power to the tail rotor when reduced power is available through the main gearbox, such as during inoperative engine events. In the event that less power is available from an engine, torque or power may be provided by the tail rotor supplemental drive system by an electric system to provide a portion of the tail rotor power required, reducing power demanded by the tail rotor from the primary drive system, and increasing available power which may be delivered to the main rotor to provide a net additional thrust for operation during reduced engine power operating regimes.

It is further contemplated that the primary drive system may include a clutch as shown in FIG. 1. The clutch can be operably interposed between the main gearbox and the tail rotor system and configured to disengage the primary tail rotor drive power system from the tail rotor while the tail rotor secondary drive system provides power to the tail rotor through the secondary drive system. This allows for cessation of tail rotor rotation while the main rotor continues rotating, enhancing the safety aircraft, such as while ground personnel and/or cargo embark or disembark the rotorcraft. Prior to takeoff, the tail rotor may resume rotation using the tail rotor secondary drive system by reconnecting the tail rotor secondary drive system through the clutch to the tail rotor. Further, when the clutch disengages the tail rotor from the primary drive system, the tail rotor speed is no longer coupled in a fixed speed ration with the rotational speed of the main rotor system. This allows for coupling the tail rotor system to and to receive torque or power from the tail rotor system primary drive system during flight regimes which demand high tail rotor power, and decoupling the tail rotor from the tail rotor primary drive system while the tail rotor secondary drive system (at a speed which not dependent on the speed of the primary drive system) drives the tail rotor during flight regimes where demand low tail rotor power. This enables the tail rotor to be driven at slower speeds, potentially improving acoustical characteristics of the rotorcraft during certain flight regimes. The clutch can also enable decoupling the tail rotor from the primary drive system, thereby allowing the secondary drive system to provide power to the tail rotor when power is not available from the primary drive system, such as during an engine-out event. In further embodiments, secondary drive system kits are provided. The secondary drive system kits enable hybridizing rotorcraft configured without supplemental tail rotor drive systems without requiring without significant rework, transmission, and/or packaging of rotorcraft systems.

The methods and systems of the present disclosure, as described above and shown in the drawings, provide for rotorcraft with superior properties including systems for providing supplemental torque through a secondary drive system to the rotorcraft tail rotor, such as along the rotorcraft tail rotor primary drive system or to the tail rotor shaft adjacent the tail rotor assembly. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A helicopter, comprising:
a tail rotor;
a primary drive system connected to the tail rotor; and
a secondary drive system operably coupled to the tail rotor and configured to supplement torque applied by the primary drive system to the tail rotor.

2. A helicopter as recited in claim 1, further including an engine operably coupled to the tail rotor through the primary drive system.

3. A helicopter as recited in claim 1, wherein the secondary drive system includes an electric power source operably coupled to the tail rotor through the secondary drive system.

4. A helicopter as recited in claim 3, wherein the secondary drive system includes:
an overrunning clutch connected to the tail rotor;
a ring gear connected to the overrunning clutch;
a pinion gear intermeshed with the ring gear; and
an electric motor connected to the pinion gear, wherein the electric motor is connected to the electric power source.

5. A helicopter as recited in claim 3, wherein the primary drive system includes a drive shaft disposed along a tail of the helicopter, wherein the electric motor is operably connected to the drive shaft.

6. A helicopter as recited in claim 3, wherein the electric motor is located on a tail rotor pylon supporting the tail rotor.

7. A helicopter as recited in claim 3, further including:
an overrunning clutch connected to the tail rotor;
a permanent magnet connected to the overrunning clutch; and
a coil fixed relative to the permanent magnet, wherein the coil is connected to the electric power source for energizing the coil to apply torque to the tail rotor.

8. A helicopter as recited in claim 3, wherein the electric power source is selected from a group including a battery, a capacitor, a flywheel, and a generator.

9. A helicopter as recited in claim 1, further including leads extending from the electric power source to a tail rotor pylon mounting the tail rotor.

10. A helicopter as recited in claim 1, wherein the secondary drive system includes a pressurized hydraulic fluid source operably coupled to the tail rotor through the secondary drive system.

11. A helicopter as recited in claim 10, further including:
an overrunning clutch connected to the tail rotor;
a torque converter connected to the overrunning clutch;
a fluid supply conduit fluidly connecting the torque converter with the pressurized hydraulic fluid source; and
a fluid return conduit fluidly connecting the torque converter with the hydraulic fluid source.

12. A helicopter as recited in claim 10, further including:
a torque converter integrally connected to a tail rotor shaft; and
a throttling valve connected between the pressurized hydraulic fluid source and the torque converter, wherein the pressurized hydraulic fluid source includes a gearbox lubricant supply.

13. A helicopter as recited in claim 10, further including:
an overrunning clutch connected to the tail rotor;
a ring gear connected to the overrunning clutch; and
a hydraulic motor with a pinion gear intermeshed with the ring gear, wherein the hydraulic motor includes an inlet and an outlet in fluid communication with the pressurized hydraulic fluid source.

14. A helicopter as recited in claim 13, wherein the hydraulic motor is disposed within the tail rotor gear box housing.

15. A helicopter as recited in claim 1, wherein the secondary drive system includes a pressurized gas source operably coupled to the tail rotor through the secondary drive system.

16. A helicopter as recited in 15, further including:
an expansion turbine connected to the tail rotor; and
a supply plenum fixed relative to the expansion turbine, wherein the supply plenum is in fluid communication with the pressurized gas source and the expansion turbine.

17. A helicopter as recited in claim 15, wherein the pressurized gas source includes at least one of a compressor section of a main engine, a compressor section of an auxiliary power unit, and an auxiliary compressor.

18. A method of applying torque to a helicopter tail rotor, comprising:
receiving a tail rotor torque setting;
comparing the tail rotor torque setting to a predetermined torque setting;
applying torque to a tail rotor using a primary drive system if the received tail rotor torque setting is less than or greater than the predetermined torque setting; and
applying torque to the tail rotor using a secondary drive system if the received tail rotor torque setting is greater than the predetermined torque setting.

19. A method as recited in claim 18, further including:
determining torque at a location on the primary drive system; and
wherein applying torque to the tail rotor using the secondary drive system includes applying to torque to the primary drive system at a location between the location where torque is determined and the tail rotor.

20. A helicopter tail rotor drive system, comprising:
a tail rotor;
a primary drive system connected to the tail rotor;
a secondary drive system connected to the tail rotor by the primary drive system; and
a control module including instructions that, when read by the control module cause the control module to:
receive a tail rotor torque setting;
compare the tail rotor torque setting to a predetermined torque setting;
apply torque to a tail rotor using a primary drive system if the received tail rotor torque setting is less than the predetermined torque setting; and
apply torque to the tail rotor using a secondary drive system if the received tail rotor torque setting is greater than the predetermined torque setting.
